(19) United States
(12) Patent Application Publication
(10) Pub. No.: US 2005/0031390 A1
(43) Pub. Date: Feb. 10, 2005

(54) Image capture device with a telescopic hinge

(76) Inventor: Gerardo Orozco-Abundis, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/636,120

(22) Filed: Aug. 7, 2003

(51) Int. Cl. G03G 15/00

(52) U.S. Cl. 399/380

(57) ABSTRACT

In accordance with an embodiment of the present invention, an image capture device comprises a housing and at least one telescopic hinge operable to couple a lid to the housing.

### TECHNICAL FIELD OF THE INVENTION

The present invention relates generally to the field of image capture devices, and more particularly to an image capture device with a telescopic hinge.

### BACKGROUND OF THE INVENTION

Today's computer users utilize many electronic devices in addition to the standard personal computer and printer. For example, scanners have become ubiquitous as many users and their employers attempt to go “paperless,” or reduce the amount of hard copy documentation that they must store, duplicate, distribute, search through, and maintain. Many scanners provide a simple lid to eliminate or reduce interference from ambient light sources during the scanning process. The lid may also be used to press down and hold the object being scanned so that the object is kept generally flat during the scanning process. However, many of these objects, for example books, are too bulky to fit and be properly held under the lid. It is also very difficult to keep such objects flat against the scanner platen during the scanning process. In such a scenario, scanned data usually varies in readability as a result of non-uniformities in the scanning process.

### SUMMARY OF THE INVENTION

In accordance with an embodiment of the present invention, an image capture device comprises a housing and at least one telescopic hinge operable to couple a lid to the housing.

In accordance with another embodiment of the present invention, an image capture device comprises a lid, a housing and at least two telescopic hinges, each having a plurality of extensible segments, the at least two telescopic hinges pivotally coupling the lid to the housing.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a perspective view of an image capture device utilizing an embodiment of the present invention; and

FIG. 2 is an exploded view of an exemplary telescopic hinge in accordance with an embodiment of the present invention.

### DETAILED DESCRIPTION OF THE DRAWINGS

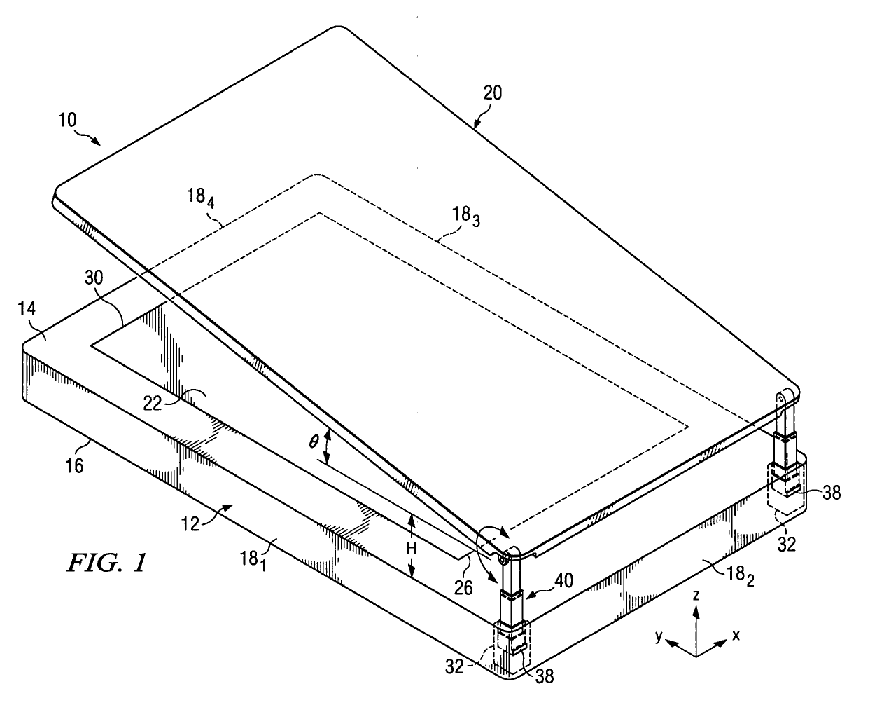

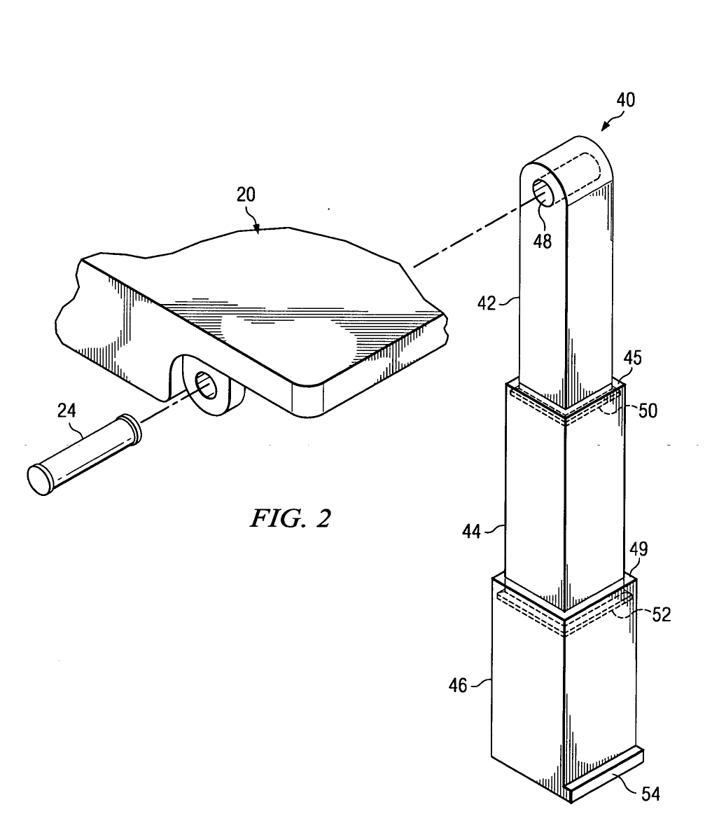

The preferred embodiment of the present invention and its advantages are best understood by referring to FIGS. 1 through 2 of the drawings, like numerals being used for like and corresponding parts of the various drawings.

The present invention will be described herein with reference to an image capture device, such as a scanner. The teachings of the present invention may be used with respect to other types of image capture devices, such as photocopiers, multi-function devices, facsimile machines, or other machines that make a digital image for storage, transmission and further processing.

FIG. 1 is a perspective view of an image capture device 10 utilizing an embodiment of the present invention. Device 10 comprises a housing 12, which in the illustrated embodiment is generally disposed in an X-Y plane. Housing 12 comprises a top surface 14 and a bottom surface 16 opposite top surface 14. Housing 12 also comprises a plurality of vertical sides 18₁, 18₂, 18₃ and 18₄. Top surface 14 comprises a transparent platen 22 against which an object to be scanned may be placed. Platen 22 comprises a first end 26 and a second end 30 opposite first end 26.

Device 10 comprises a lid 20. Lid 20 is coupled to housing 12 using at least one hinge 40. In the illustrated embodiment, lid 20 is coupled to housing 12 using two hinges. If desired, in an alternative embodiment, a greater or fewer number of hinges may be used. Housing 12 comprises at least one recess 32, one for each hinge 40. In the illustrated embodiment, because there are two hinges, housing 12 comprises two recesses. Recesses 32 are preferably located in proximity to first end 26 of platen 22 along a width of device 10. If desired, recesses 32 may be provided along a length of device 10.

Hinge 40 is preferably a telescopic hinge comprising of a plurality of segments as discussed in detail herein with reference to FIG. 2. Referring to FIG. 1, the telescopic nature of hinge 40 enables lid 20 to be raised to accommodate bulky objects, such as books, for scanning. A release mechanism may be provided to release hinge 40 from housing 12. One example of a release mechanism comprises at least one slot 38 provided on a vertical side, for example side 182, of housing 12, through which a latching member 54 (FIG. 2) of a segment 46 of hinge 40 may pass. In the illustrated embodiment, two slots are provided, one for each hinge 40. Alternatively, the release mechanism may be a switch or a button that, when pushed by a user, releases hinge 40 from housing 12.

FIG. 2 is an exploded view of an exemplary telescopic hinge 40 in accordance with an embodiment of the present invention. Hinge 40 comprises a plurality of telescoping or extensible segments 42, 44, 46. In the illustrated embodiment, hinge 40 comprises three telescoping segments 42, 44, and 46. If desired, hinge 40 may comprise two segments or hinge 40 may comprise a greater number of segments. Although in the illustrated embodiment, a cross-section of segments 42, 44, and 46 is square in shape, in alternative embodiments their cross-section may be of any shape. Furthermore, if desired, segments 42, 44, and 46 may be of different shapes.

The widths of segments 42, 44 and 46 are coordinated such that segment 42, the segment with the smallest width, fits into segment 44, and segment 44 fits into segment 46, the segment with the largest width. Segment 42 is operable to slide into and inside segment 44 and segment 44 is operable to slide into and inside segment 46. Segment 46 is operable to slide into and inside recess 32 in housing 12. In an alternative embodiment, segment 46 may be anchored to housing 12. If desired, in another alternative embodiment, housing 12 may not comprise recess 32 and segment 46 may be formed as part of housing 12. In such an embodiment, segment 44 is operable to slide into and inside segment 46 and a latching member may be used to disengage segments 42 and 44 from segment 46.

In the illustrated embodiment, segment 46 is rectangular in shape and has an opening at its upper end through which segment 44 may be inserted into segment 46. Segment 46 comprises a latching member 54 to provide a releasably secure connection to housing 12. Latching member 54 may comprise a biasing element, for example a spring. Latching member 54 is disposed on a side of segment 46 which is proximal to slot 38 of housing 12 and is used to releasably couple segment 46 with housing 12. Latching member 54 is operable to engage with slot 38 to securely hold hinge 40 in recess 32 and prevent segment 46 from inadvertently decoupling from housing 12. However, when it is desirable to disengage latching member 54 from slot 38 of housing 12, for example to release lid 20 from housing 12, a user may simply push latching member 54 out of slot 38 to disengage it from slot 38.

Segment 44 is slidably engaged with segment 46 and is operable to slide along a longitudinal axis of segment 46. Segment 44 has an opening at its upper end through which segment 42 may be inserted. Segment 44 comprises a latching member 52. Latching member 52 is preferably disposed around an end of segment 44 which is distal from the opening in segment 44.

Segment 42 is slidably engaged with segment 44 and is operable to slide along a longitudinal axis of segment 44. Segment 42 comprises a latching member 50 preferably disposed around a lower end of segment 42. Segment 42 has a channel 48 near its upper end through which a pin 24 may be inserted. Pin 24 facilitates pivotal coupling of lid 20 to hinge 40. If desired, the upper end of segment 42 may be curved so that lid 20 may more easily pivot around pin 24.

In the illustrated embodiment, the opening of segment 46 is surrounded by a ledge 49 and the opening of segment 44 is surrounded by a ledge 45. In an alternative embodiment, ledge 45 and/or ledge 49 may be provided along only a portion of the openings of their respective segments. If desired, in an alternative embodiment, ledge 45 and/or ledge 49 may be provided anywhere along the inner walls of their respective segments. Latching member 52 is operable to engage with ledge 49 of segment 46 to prevent segment 44 from being inadvertently disengaged from segment 46. Latching member 50 is operable to engage with ledge 45 of segment 44 to prevent segment 42 from being inadvertently disengaged from segment 44.

Referring to FIGS. 1 and 2, segment 46 is disposed in recess 32 such that at least a lower end of segment 46 resides inside recess 32. When hinge 40 is in a collapsed or lowered state, segment 42 is housed mostly inside segment 44, segment 44 is housed inside segment 46, and segment 46 is housed in recess 32, such that the height of hinge 40 is approximately equal to the height of segment 46. If desired, in an alternative embodiment, a portion of a segment may be extending out of the segment in which it is housed. In the collapsed state, latch member 54 may not engage with slot 38. If desired, in the collapsed state, latch member 54 may engage with slot 38. A user may pivot lid 20 around hinge 40, for example by an angle 0, to place an object to be scanned on platen 22.

If desired, the end of lid 20 in proximity to hinge 40 may be raised, for example to accommodate a bulky object, by extending hinge 40. Hinge 40 may be extended to a desired height H by sliding one or more segments 42, 44, and 46, along one or more of the other segments or along recess 32. Thus, for example segment 46 may extend out from recess 32, segment 44 may extend out from segment 46 and/or segment 42 may extend out from segment 44. Depending on the extent to which segment 46 is extended from recess 32, latch member 54 may engage with slot 38 to prevent segment 46 from inadvertently decoupling from housing 12. Similarly, as hinge 40 elongates, latching member 52 engages with ledge 49 to prevent segment 44 from inadvertently disengaging from segment 46, and latching member 50 engages with ledge 45 to prevent segment 42 from inadvertently disengaging from segment 44.

After placing an object on platen 22, the user may close lid 20 and apply pressure on lid 20 to press the object against platen 22. Because hinge 40 is a telescoping hinge, the portion of lid 20 near end 26 of platen 22 may be raised in the direction of the Z-axis, such that lid 20 is substantially parallel to top surface 14. This enables more uniform pressure to be applied on the object during the scanning process. In an alternative embodiment, the weight of lid 20 may itself cause the portion of lid 20 near end 26 to rise to accommodate the thickness of the object placed on platen 22. The object may then be scanned. After the object is removed from platen 22, the weight of lid 20 may itself cause the portion of lid 20 near end 26 to collapse causing hinge 40 to return to a collapsed state.

If desired, lid 20 may be released from housing 12. In the illustrated device 10, in order to release lid 20, the user may apply pressure on latching member 54 of segment 46 through slot 38 to disengage latching member 54 from slot 38. Hinge 40 is then simply pulled out of recess 32 to remove lid 20 from housing 12.

A technical advantage of an exemplary embodiment of the present invention is that it enables accommodation of a bulky object between the lid and the platen. Another technical advantage of an exemplary embodiment of the present invention is that more uniform pressure may be applied to the object to be scanned. Another technical advantage of an exemplary embodiment of the present invention is that the lid with the telescopic hinge(s) may be used with an image capture device having a very thin housing.

1. An image capture device, comprising:
a housing; and
at least one telescopic hinge operable to couple a lid to said housing.

2. The image capture device of claim 1, wherein said at least one telescopic hinge releasably couples said lid to said housing.

3. The image capture device of claim 1, further comprising at least one slot in said housing, said at least one slot operable to engage with at least a portion of said at least one telescopic hinge to prevent inadvertent decoupling of said at least one telescopic hinge from said housing.

4. The image capture device of claim 1, wherein said housing comprises at least one recess corresponding to said at least one telescopic hinge.

5. The image capture device of claim 1, wherein said housing comprises at least one recess, each of said at least one telescopic hinge being inserted into a corresponding one of said at least one recess to couple said lid with said housing.

6. The image capture device of claim 1, wherein said at least one telescopic hinge comprises a plurality of segments.

7. The image capture device of claim 1, wherein said at least one telescopic hinge comprises at least one segment slidably engaged with at least another segment.

8. The image capture device of claim 1, wherein at least one segment of said at least one telescopic hinge is adapted to be disposed in a recess of said housing.

9. The image capture device of claim 8, wherein at least another segment of said at least one telescopic hinge is slidably engaged with said at least one segment.

10. The image capture device of claim 9, wherein a third segment of said at least one telescopic hinge is slidably engaged with said at least another segment.

11. An image capture device, comprising:
a lid;
a housing; and
at least two telescopic hinges, each having a plurality of extensible segments, said at least two telescopic hinges pivotally coupling said lid to said housing.

12. The image capture device of claim 11, wherein a first segment of said plurality of segments comprises a latching member operable to engage with a slot in said housing.

13. The image capture device of claim 11, wherein a first segment of said plurality of segments comprises a ledge near an end of said first segment.

14. The image capture device of claim 13, wherein said ledge surrounds an opening at said end.

15. The image capture device of claim 13, wherein a second segment of said plurality of segments comprises a latching member operable to engage with said ledge.

16. The image capture device of claim 15, wherein said latching member surrounds an end of said second segment.

17. The image capture device of claim 11, wherein said at least two telescopic hinges releasably couple said lid to said housing.

18. The image capture device of claim 11, wherein a segment of said plurality of segments comprises a channel operable to accept a pin to pivotally couple said lid to said hinge.
